(19) United States
(12) Patent Application Publication
(10) Pub. No.: US 2001/0029602 A1
(43) Pub. Date: Oct. 11, 2001

(54) System development method, development-support system and storage medium storing program of same

(75) Inventor: Yuji Uota, Tokyo (JP)

Correspondence Address: David A. Blumenthal, FOLEY & LARDNER, Washington Harbour, 3000 K Street, N.W., Suite 500, Washington, DC, 20007-5109, US

(73) Assignee: NEC CORPORATION

(21) Appl. No.: 09/824,692

(22) Filed: Apr. 4, 2001

(30) Foreign Application Priority Data
Apr. 5, 2000 (JP) 2000-104029

(51) Int. Cl. G06F 9/44

(52) U.S. Cl. 717/1

(57) ABSTRACT

A system development method is provided which enables a prompt and proper correction of a malfunction of a functional unit and enables the malfunction of the functional unit and results of corrections made to correct the malfunction to be surely notified to all developers who are developing systems using the functional unit.

The system development method uses a development-support system in which a server used to provide macro information and macro files, clients to develop macros and clients to develop semiconductor devices by combining macros are connected through the Internet. Clients to develop semiconductor devices, by registering macro users, by referring to macro information and by obtaining files of two or more macros and combining them, develop semiconductor devices, check operations of them and, when the semiconductor devices do not operate properly due to malfunctions of the macro, transmit question information about the macro to the server and, based on replied information, obtain files of another macros, then change design to have another try of developing semiconductor devices and checking their operations.

### BACKGROUND OF THE INVENTION

1. Field of the Invention

The present invention relates to a system development method, development-support system and storage medium storing programs of the same and more particularly to the system development method for developing hardware and/or software of a semiconductor device or alike, or a system in which they are mixed, by using a network including the Internet, intranet or a like, and to the storage medium storing programs of the same and the storage medium storing programs to operate the development-support system used for supporting system development and development-support system control programs to control the development-support system.

The present application claims priority of Japanese Patent Application No. 2000-104029 filed on Apr. 5, 2000, which is hereby incorporated by reference.

2. Description of the Related Art

A semiconductor device including an LSI (Large Scale Integrated Circuit) made up of one million or more transistors can be implemented as it becomes highly integrated and its packaging densities increase. One example is a system LSI constructed by integrating systems in which a CPU (Central Processing Unit), storage devices such as ROM (Read Only Memory) and RAM (Random Access Memory), buffers, and a plurality of peripheral devices performing a variety of signal processing are connected by buses, signal lines, or a like, into one semiconductor chip.

Since circuits of such the system LSI are large in size, it is impossible to perform circuit design directly at a transistor level. Therefore, in order for each of the CPU, ROM, RAM, buffer, and two or more peripheral devices to implement a desired function as one functional block, it is necessary to perform, sequentially and in stages, system design for defining and determining operations and configurations of an entire system, function design for determining relationships among functional blocks and operations within each of functional blocks in accordance with specifications decided by the system design, detailed logic design for constructing each of functional blocks by combining basic gates such as NAND gates and/or NOR gates, and circuit design for deciding characteristics of electronic circuits and logical devices at the transistor level so as to meet circuit specifications based on logic design including the function design and detailed logic design. Moreover, simulation of operations using a computer and verification to check if desired functions can be obtained at each design stage are necessary.

Conventionally, at a stage of logic design, following works are done. First, a logic designer, in accordance with specifications decided by the system design, performs the function design for determining or defining relationships among functional blocks including the CPU and/or two or more peripheral devices, or the like and operations within each of the functional blocks. Next, the logic designer, by manipulating a keyboard or a mouse making up a special-purpose computer used for the logic design of semiconductor devices or a general-purpose computer storing programs used for logic design of the semiconductor devices and by combining basic logic elements such as NAND gates and/or NOR gates or basic logic circuits such as latches, counters, or likes formed by the combination of these basic logic elements, performs detailed logic design for implementing each of the functional blocks whose internal operations are determined by the above function design and forms a simulation model of the semiconductor device. The basic logic element or basic logic circuit described above is called a macro and functions of the macro are described in programming languages such as an HDL (Hardware Description Language) or C language (trade name) and is stored, in advance, in storage media such as a FD (Floppy-Disk), HD (Hard-Disk), CD-ROM, or a like. Then, the logic designer, after compiling the simulation model of the semiconductor device thus formed together with libraries of macros stored in storage media such as the FD, HD, CD-ROM, or the like and read from external storage media corresponding to these storage media, has a computer to execute a simulation program for verification of the semiconductor.

In the conventional logic design described above, when a result of the simulation and verification reveals a presence of a malfunction and it turns out that the malfunction is attributable to a malfunction of a macro, following measures have been taken, which have caused inconveniences described below.

That is, since a logic designer who has found malfunctions of the macro ordinarily asks questions about the malfunctions of the macro individually by a telephone, facsimile, or a like, in some cases, a notification informing that malfunctions occur in the macro is not provided to other logic designers who are designing a system LSI by using the macro or is provided in a delayed manner. Because of this, if other designers have continued the logic design of the system LSI without becoming aware of malfunctions of the macro, in some cases, the malfunctions occur after completion of the product, causing a great damage. Moreover, if many logic designers ask the macro developer the same questions about the malfunctions of the macro individually, since the macro developer has to respond individually, it interferes with original works of the macro developer or it reduces time that has to be used for correction of malfunctions of the macro, thus making it impossible for the macro developer to promptly respond to desires of logic designers who have asked such questions.

Moreover, ordinarily, malfunctions of only macros that presently exist in a library being recognized by the macro developer are corrected and malfunctions of macros existing in a storage medium as a library that has been already distributed to logic designers are not corrected except those of macros to which questions are positively put. Though it is necessary to provide a prompt notification about the malfunctions to logic designers who seem to be using the macro in question, since there has been conventionally no means for specifically knowing what kinds of macros logic designers are using or which logic designer use macros, it has been difficult to identify a logic designer with whom a macro developer has to contact. However, contact with all logic designers requires too much time and labor. Therefore, if the logic designer who is using the macro in question but is not informed of the malfunctions and corrections made to the malfunctions does the logic design of the system LSI without becoming aware of such the malfunctions, delays in developing the system LSI occur and, in some cases, a great damage may occur because the macro used for the development is found to have a defect after the production has been completed. Moreover, notifications about the defects provided to any logic designer who is not using the macro in question causes confusion.

Furthermore, there is a case where a macro has its parent macro which has been used as a model for development of a child macro. In ordinary cases, information about relationships between the child macro and parent macro is not described in a library and developers of the macro hold the information merely in the form of a memorandum. Therefore, when a malfunction of the child macro is attributable to a malfunction of the parent macro, the developer of the parent macro is not notified of the malfunction, which causes delays in corrections to be made to the child macro.

Inconveniences described above occur also in development of software. Though software being small in size and quantity can be developed by one developer, in the case of software being large in size and quantity, it is made up of a plurality of routines that perform predetermined processing and a plurality of developers develop each of the plurality of routines individually and finally the plurality of routines are integrated into one piece of software. When a version is updated and even when new software is developed, it is not that all routines are developed right from the start, but that several routines that have been already developed are combined and only a routine to incorporate new functions is developed in some cases. Therefore, when it is considered that each routine is equivalent to a macro and a developer controlling development of entire software is equivalent to the logic designer described above, the same inconvenience as in the case of the development of macros occurs in the software. Hereinafter, when the above macro and routine are generically referred, they are called a “functional unit” in a sense that they implement a unified function.

### SUMMARY OF THE INVENTION

In view of the above, it is a first object of the present invention to provide a system development method and a development-support system which enable prompt and proper corrections of malfunctions of functional units and enable malfunctions of the functional units or results of corrections made to malfunctions to be surely notified to all developers of a system using the functional units, thus allowing the system to be promptly developed, and a storage medium storing programs of the system development method and the development-support system.

According to a first aspect of the present invention, there is provided a system development method for developing a system using a development-support system made up of a server used to provide information about functional units each implementing a different function and files describing the different functions, at least one developer client to develop the functional units and at least one user client to develop the system configured to perform desired operations by combining the functional units, wherein all of the server, developer client, and user client are connected through the Internet, including:

a first step, to be taken by the user client, of registering an operator of the user client as a user of the development-support system;

a second step, to be taken by the user client, of obtaining, by referring to information about the functional units, files describing a plurality of the functional units which are needed for development of the system;

a third step, to be taken by the user client, of developing the system by combining files describing the plurality of functional units;

a fourth step, to be taken by the user client, of transmitting question information about the functional units or keyword information regarding information required for development of the system to the server, when the system does not operate properly due to malfunctions of the functional units or when information required for development of the system is to be acquired; and

a fifth step, to be taken by the user client, of obtaining, when necessary, a file of another functional units, based on reply information to the question information or on information retrieved according to the keyword information and, if necessary, of changing design to have another try of developing the system and checking operations of the developed system.

In the foregoing, a preferable mode is one wherein, in the second step, the files of the plurality of functional units are allowed to be obtained only when an application for individual or collective acquisition of the files is made and a right to acquire the files is granted through examination of the application for acquisition of each of the functional units or of every collective group of the functional units.

Also, a preferable mode is one wherein, in the fourth step, when any question about the functional units that has been already asked is contained in the question information, a notification informing that the question about the functional units has been already asked is provided, and other information required for development of the system is able to be obtained.

Also, a preferable mode is one wherein, the reply information to the question information is transmitted to each of both user clients and developer clients which is operated by a user having already acquired the files including a user having transmitted the question information, a user having wanted to obtain the files but having not yet obtained the files and, when there is a model functional unit that has been used as a model for development of the functional unit, a user having developed the model functional unit.

Also, a preferable mode is one that wherein includes a sixth step of transmitting, when the developer of the functional units has found a malfunction of the functional units, contact information notifying that the functional units have the malfunction and information about a method for taking a measure against the malfunction.

Also, a preferable mode is one wherein, wherein the system is a semiconductor device and the functional unit is a basic logic element or a basic logic circuit constructed by combining a plurality of the basic logic elements.

Also, a preferable mode is one wherein the system is a semiconductor device and the functional units include a CPU (Central Processing Unit), storage device, buffer, and peripheral device and wherein a file of the peripheral device is so constructed as to be able to select either of a file to implement its function by using hardware or a file to implement its function by using software.

Also, a preferable mode is one wherein, the system is software and the functional units are routines or objects to perform predetermined processing.

According to a second aspect of the present invention, there is provided a storage medium storing system development programs to have functions described above implemented, in a computer.

According to a third aspect of the present invention, there is provided a development-support system including:

a server used to provide information about functional units each implementing a different function and files describing the different function,

at least one developer client to develop the functional units:

at least one user client to develop a system configured to perform desired operations by combining the functional units; and

wherein all of the server, the developer client and the user client are connected through the Internet,

wherein the user client obtains files of a plurality of functional units, develops the system by combining files of the plurality of functional units and checks operations of the developed system and, as a result, when the developed system does not operate properly due to a malfunction of any one of the functional units, transmits question information about the malfunction of the functional unit to the server,

wherein the server, after having accepted and registered the question information, transmits the question information to a developer client operated by a developer of the functional units,

wherein the developer client transmits reply information about the question information to the server,

wherein the server, after having accepted and registered the reply information, transmits the reply information to a user client or other developer client operated by a user having interests in the functional units.

In the foregoing, it is preferable that the user client makes an application for acquisition of each of a plurality of functional units or of the plurality of functional units collectively, the server examines the application for each of the plurality of functional units or for the plurality of functional units collectively and grants the user client a right to acquire, and the user client, based on the granted right, obtains files of the functional unit from the server.

Also, it is preferable that the server, only when the question information has been registered as coming from a user of the development-support system and the question information has been transmitted from a user having obtained files of the functional units, accepts the question information.

Also, it is preferable that the server, when having already accepted and registered question information about the functional units, registers the question information together with question information that has been already registered and transmits contents of the registration to the developer client.

Also, it is preferable that the server transmits a date when a reply to the question information should be made to the developer client and, if there is no reply by the date, transmits information urging the developer client to make a reply and, if there is still no reply even after the date, again transmits information urging the developer client to make a reply on every predetermined date, to the developer client.

Also, it is preferable that the server transmits information notifying that a predetermined penalty is imposed every time the reply is delayed by one date behind the date or by predetermined dates behind the date, together with the information urging the developer client to make the reply, and an amount equivalent to the penalty is automatically drawn from a bank account every time the reply is delayed by one date behind the date or by predetermined dates behind the date.

Also, it is preferable that the server accepts the reply information only when the reply information has been transmitted by a user who has been registered as a user of the development-support system and who has developed the functional unit.

Also, it is preferable that the interested user is a user having obtained files including a user having transmitted the question information, a user having wanted to obtain the files but having not yet obtained the files or, when there is a model functional unit that has been used as a model for development of the functional unit, a user having developed the model functional unit.

Also, it is preferable that the developer client transmits, when the developer of the functional unit has found a malfunction of the functional unit, contact information notifying that the functional unit has the malfunction and information about a method for taking a measure against the malfunction, to the server.

Also, it is preferable that the system is a semiconductor device and the functional unit is a basic logic element or a basic logic circuit constructed by combining a plurality of the basic logic elements.

Also, it is preferable that the system is a semiconductor device and the functional unit is a CPU, storage device, buffer, and peripheral device and wherein a file of the peripheral device is so constructed as to be able to select either of a file to implement its function by using hardware or a file to implement its function by using software.

Furthermore, it is preferable that the system is software and the functional units are routines or objects to perform predetermined processing.

According to a fourth aspect of the present invention, there is provided a storage medium storing system development control programs to have functions described above implemented, in a computer.

With the above configurations, even if there are malfunctions of the functional units, corrections are made to the malfunctions promptly and properly and the malfunctions are surely notified to all developers who are developing a system using the functional units. This enables a prompt and accurate development of the system.

### BRIEF DESCRIPTION OF THE DRAWINGS

The above and other objects, advantages and features of the present invention will be more apparent from the following description taken in conjunction with the accompanying drawings in which:

FIG. 1 is a block diagram showing configurations of a semiconductor device development-support system according to an embodiment of the present invention;

FIG. 2 is a conceptual diagram showing an example of configurations of information (macro information) to be stored in a storage device according to the embodiment of the present invention;

FIG. 3 is a diagram showing an example of configurations of a macro name information table in the storage device of the embodiment of the present invention;

FIG. 4 is a diagram showing an example of configurations of a macro information table in the storage device of the embodiment of the present invention;

FIG. 5 is a diagram showing an example of configurations of a macro function information table in the storage device of the embodiment of the present invention;

FIG. 6 is a diagram showing an example of configurations of a process information table in the storage device of the embodiment of the present invention;

FIG. 7 is a diagram showing an example of configurations of a macro differentiation information table in the storage device of the embodiment of the present invention;

FIG. 8 is a diagram showing an example of configurations of a CPU name differentiation information table in the storage device of the embodiment of the present invention;

FIG. 9 is a diagram showing an example of configurations of an interface classification information table in the storage device of the embodiment of the present invention;

FIG. 10 is a diagram showing an example of configurations of a macro developer information table in the storage device of the embodiment of the present invention;

FIG. 11 is a diagram showing an example of configurations of a macro user information table in the storage device of the embodiment of the present invention;

FIG. 12 is a diagram showing an example of configurations of a download information table in the storage device of the embodiment of the present invention;

FIG. 13 is a diagram showing an example of configurations of a QA information table in the storage device of the embodiment of the present invention;

FIG. 14 is a flowchart showing an example of processing of development of a macro according to the embodiment of the present invention;

FIG. 15 is a flowchart showing an example of processing of development of a semiconductor device according to the embodiment of the present invention;

FIG. 16 is a flowchart showing an example of processing of obtaining information about the macro according to the embodiment of the present invention;

FIG. 17 is also a flowchart showing an example of processing of obtaining information about the macro according to the embodiment of the present invention;

FIG. 18 is a flowchart showing an example of processing of solving questions about the macro according to the embodiment of the present invention; and

FIG. 19 is a flowchart showing an example of processing of providing information about the macro according to the embodiment of the present invention.

### DETAILED DESCRIPTION OF THE PREFERRED EMBODIMENTS

Best modes of carrying out the present invention will be described in further detail using various embodiments with reference to the accompanying drawings.

Embodiment

FIG. 1 is a schematic block diagram showing configurations of a semiconductor device development-support system according to an embodiment of the present invention.

The semiconductor device development-support system of the embodiment chiefly includes a server 1, a storage device 2, the Internet 3, clients 4₁ to 4ₘ (m is a natural number) to be operated for development of a macro by a developer (macro developer) having developed the macro and clients 5₁ to 5ₙ, (n is a natural number) to be operated for development of a semiconductor device by a logic designer (macro user) being a user of the macro. The server 1, clients 4₁ to 4ₘ, and clients 5₁ to 5ₙ are connected through the Internet 3. The server 1 is made up of a computer having a CPU, internal storage devices including a ROM, RAM, or a like, external storage devices including an FDD, HDD, CD-ROM driver, or a like in which an FD, HD, and CD-ROM are installed, outputting units including a CRT display, a liquid crystal display, or a like, inputting units including a keyboard, mouse, or a like and a communication unit used to carry out data communication with the clients 4₁ to 4ₘ and clients 5₁ to 5ₙ with the Internet 3 and, in response to requests from the clients 4₁ to 4ₘ and clients 5₁ to 5ₙ, feeds data on macros stored in the storage device 2 through the Internet 3 and controls the semiconductor device development-support system. The storage device 2 is made up of the HDD or the like to which the HD storing data on macros is installed. Each of the clients 4₁ to 4ₘ and clients 5₁ to 5 ₙ is made up of a computer having a CPU, internal storage devices including a ROM, RAM, or a like, external storage devices including an FDD, HDD, CD-ROM driver, or the like in which an FD, HD, and CD-ROM are installed, outputting unit including a CRT display, liquid crystal display, or a like and a communication unit used to carry out data communication with the server 1 through the Internet 3.

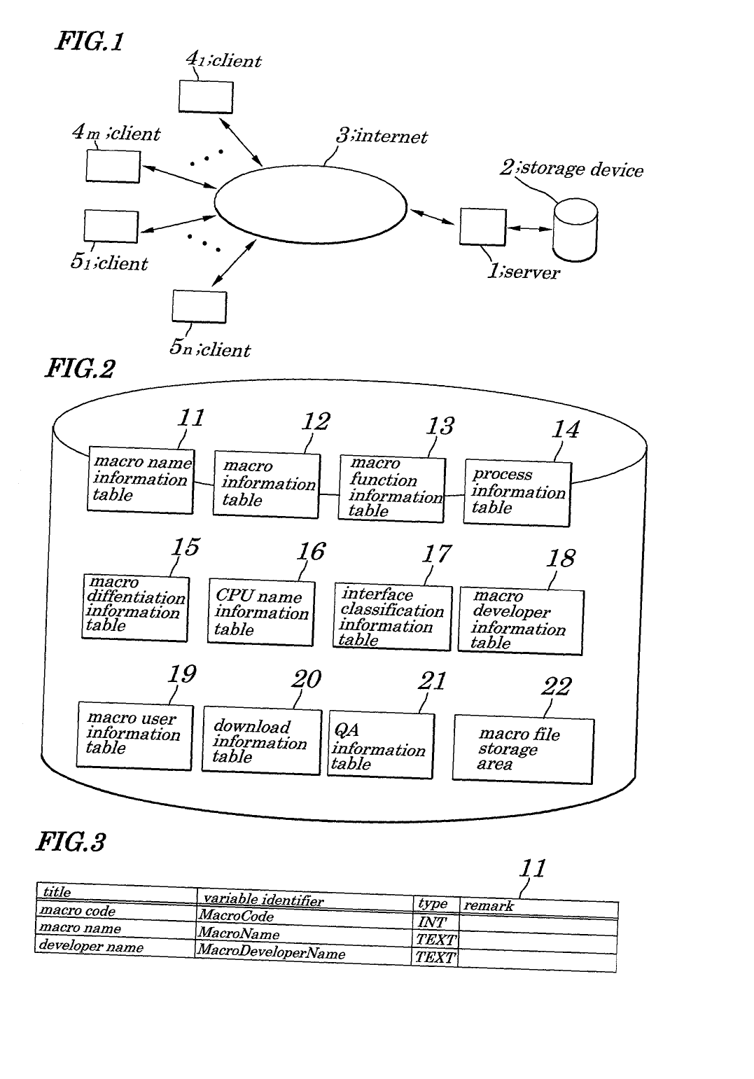

FIG. 2 is a conceptual diagram showing an example of configurations of information (macro information) to be stored in the storage device 2 according to the embodiment of the present invention. As shown in FIG. 2, the storage device 2 (shown in FIG. 1) has a macro name information table 11, a macro information table 12, a macro function information table 13, a process information table 14, a macro differentiation information table 15, a CPU name information table 16, an interface (I/F) classification information table 17, a macro developer information table 18, a macro user information table 19, a download information table 20, a QA information table 21, and a macro file storage area 22.

In the macro name information table 11, as shown in FIG. 3, are stored a macro code assigned to the macro, a macro name assigned to the macro, and a name of a macro developer who has developed the macro and, as variable identifiers, MacroCod, Macroname, and MacroDeveloperName are assigned respectively. The macro code is represented by a several-digit integer (not shown) and each of the macro name and macro developer name is represented by character strings (not shown) in a text file format.

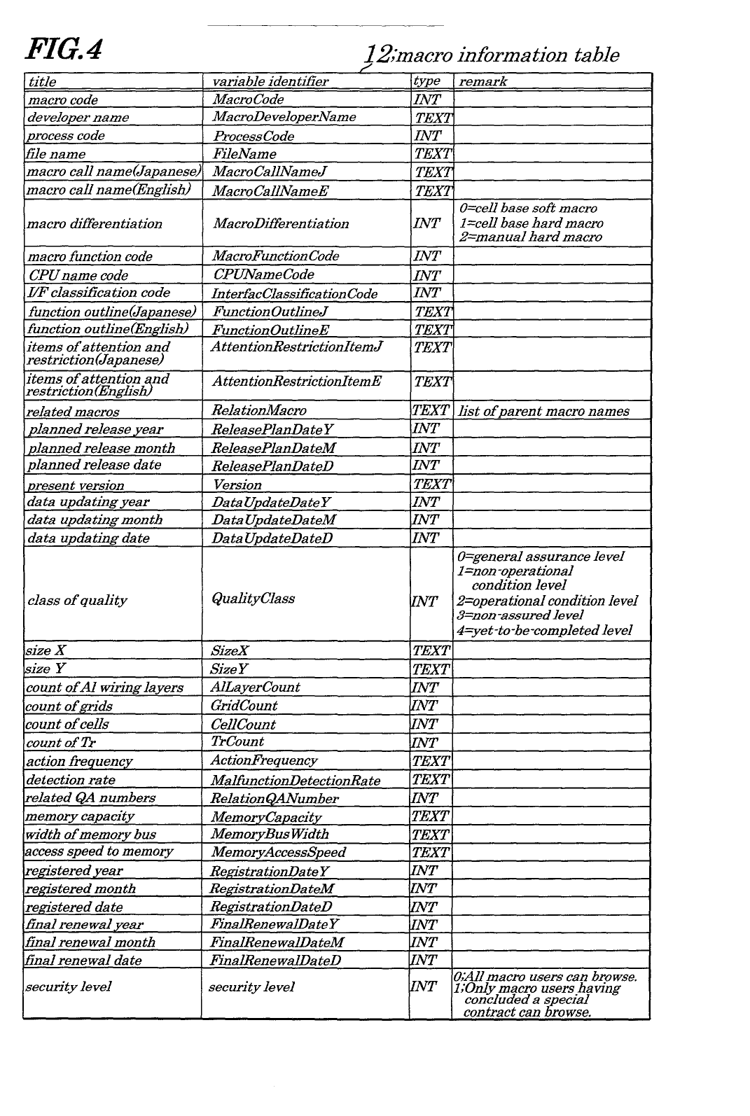

In the macro information table 12, as shown in FIG. 4, are stored a macro code, a name of a macro developer, a process code to be assigned to a process used when the macro is produced, a file name assigned to a macro file being a file in which a function of the macro developed by the macro developer and permitted to be registered is described using a programming language including HDL or C language, macro call names being call names in Japanese and English assigned to the macro (for example, 16- bit timer counter). As variable identifiers, MacroCode, MacroDeveloperName, ProcessCode, FileName MacroCallnamej, and MacroCallnameE are assigned respectively. Each of the macro code and process code is represented by a several-digit integer (not shown). Each of the macro developer name, file name, macro call names (in Japanese and English) is represented by character strings in a text file format (not shown).

Also, in the macro information table 12, as shown in FIG. 4, are stored a macro differentiation representing a type of the macro, a macro function code assigned to a function of the macro in accordance with classification by function, a code of a CPU name assigned to a CPU that can control the macro, an I/F classification code being a classification of an interface required when the macro transmits or receives data to and from an outside, a function outline which describes a function of the macro in Japanese, and a function outline which describes the function of the macro in English. As variable identifiers, MacroDifferentiation, MacroFunctionCode, CPUNameCode, InterfaceClassificationCode, FunctionOutlineL, and FunctionOutlineE are assigned respectively. As the macro differentiation, [0] is set when the macro is a “cell base soft macro” and [1] is set when the macro is a “cell base hard macro”, and [2] is set when the macro is a “manual hard macro”. Each of the macro function code, code of the CPU name, and I/F classification code is represented by a several-digit integer (not shown). Each of the function outlines in Japanese and English is represented by character strings in a text file format (not shown).

Also, in the macro information table 12, as shown in FIG. 4, are stored items, described in Japanese, of attention and restriction to be paid or taken at a time of using the macro, items, described in English, of attention and restriction to be paid or taken at the time of using the macro, related macros being a list of names of parent macros related to the macros, planned release year indicating a date scheduled to supply a macro file of the macro, planned release month, and planned release date. As variable identifiers, AttentionRestrictionItemJ, AttentionRestrictionItemE, RelationMacro, ReleasePlanDateY, ReleasePlanDateM, and ReleasePlanDateD are assigned respectively. Each of the items of attention and description (Japanese), items of attention and restriction (English), and the related macro is represented by character strings in a text file format (not shown). Each of the planned release year, planned release month and planned release date is represented by a several-digit integer (not shown).

Also, in the macro information table 12, as shown in FIG. 4, are stored a present version of the macro, data updating year, data updating month, and data updating date of a time of updating various kinds of data described in the macro information table 12, a class of quality to be provided to be operated at an assured operational condition level at the time of using the macro. As variable identifiers, Version, DataUpdateDateY, DataUpdateM, DataUpdateD, and QualityClass are assigned respectively. The present version is represented by character strings in a text file format (not shown). Each of the data updating year, data updating month and data updating date is represented by a several-digit integer (not shown). The level of quality is set to “0” when the macro is provided at a general assurance level at which the macro is assured of operations without any problem under general conditions and is set to “1” when the macro is provided at a non-operational condition level at which the macro is found not to operate under specified conditions and is set to “2” when the macro is provided at an operational condition level at which the macro is assured of operations under specified conditions and is set to “3” when the macro is provided at a non-assured level at which the macro operates only under very-limited conditions and is set to “4” when the macro is provided at a yet-to-be-completed level at which the macro is scheduled to be developed or under development.

Also, in the macro information table 12, as shown in FIG. 4, are stored a size X being a size of the macro in an X direction, a size Y being a size of the macro in a Y direction, a count of Al (Aluminum) wiring layer being the number of aluminum wiring layers of the macro, a count of grids, a count of cells being the number of standard cells making up the macro, and a count of Tr being the number of transistors making up the macro. As variable identifiers, SizeX, SizeY, AlLayerCount, GridCount, CellCount, and TrCount are assigned respectively. Each of the size X and size Y is represented by character strings in a text file format (not shown). Each of the count of the Al layers, count of grids, and count of cells is represented by a several-digit integer (not shown).

Also, in the macro information table 12, as shown in FIG. 4, are stored an action frequency of the macro, a detection rate of malfunctions, related QA numbers being a number assigned to questions about malfunctions of the macro given by the macro user or information about replies to these questions, memory capacity of memories to be used at a time of operations of the macro, memory bus width being a bit width of a bus used to connect the memory used at the time of using the macro to the macro, and an access speed to memory being a speed of an access to the memory at the time of using the macro. As variable identifiers, ActionFrequency, MalfunctionDetectionRate, RelationQANumber, MemoryCapacity, MemoryBusWidth, and MemoryAccessSpeed are assigned respectively. Each of the action frequency, detection rate of malfunctions, memory capacity, memory bus width, and access speed to memory is represented by character strings in a text file format (not shown). The related QA number is represented by a several-digit integer (not shown).

Also, in the macro information table 12, as shown in FIG. 4, are stored a registration year, registration month and registration date being a year, month, and date when a macro file of the macro is first registered with a macro file storage area 22, a final renewal year, final renewal month, and final renewal date being a year, month, and date when the macro file of the macro has been finally renewed and a security level representing a degree of security of the macro information. As variable identifiers, RegistrationDateY, RegistrationDateM, RegistrationDateD, FinalRenewalDateY, FinalRenewlDateM, FinalRenewalDateD, and SecurityLevel are assigned respectively. Each of the registration year, registration month, and registration date and final renewal year, final renewal month, and final renewal date is represented by a several-digit integer (not shown). The security level is set to “0” when the macro can be browsed by all macro users and is set to “1” when the macro can be browsed by only a macro user who has concluded a special contract with the macro developer. However, even if the security level is set to “1”, in order to provide information that can be used when a macro user decides whether the user concludes a special contract with a macro developer, a macro code, name of a macro developer, macro call name (Japanese), macro call name (English), macro differentiation, macro function code, function outline (Japanese), function outline (English), or a like can be browsed by all macro users. In many cases, the security level is set to “1” especially when the class of quality is set to “4”, that is, when the macro is provided at the yet-to-be-completed level at which the macro is scheduled to be developed or under development, however, even if the macro is scheduled to be developed, when no security is required, even while the class of quality is set to “4”, the security level is not set to “1”.

In the macro function information table 13, as shown in FIG. 5, are stored a code of a macro function, a name of a macro function in Japanese being a Japanese name of a function of each macro, which corresponds to the code of the macro function, and the name of the above macro function in English. As variable identifiers, MacroFunctionCode MacroFunctionNameJ, and MacroFunctionNameE are assigned respectively. The macro function number is represented by a several-digit integer (not shown). Each of the macro function names in Japanese and English is represented by character strings in a text file format (not shown).

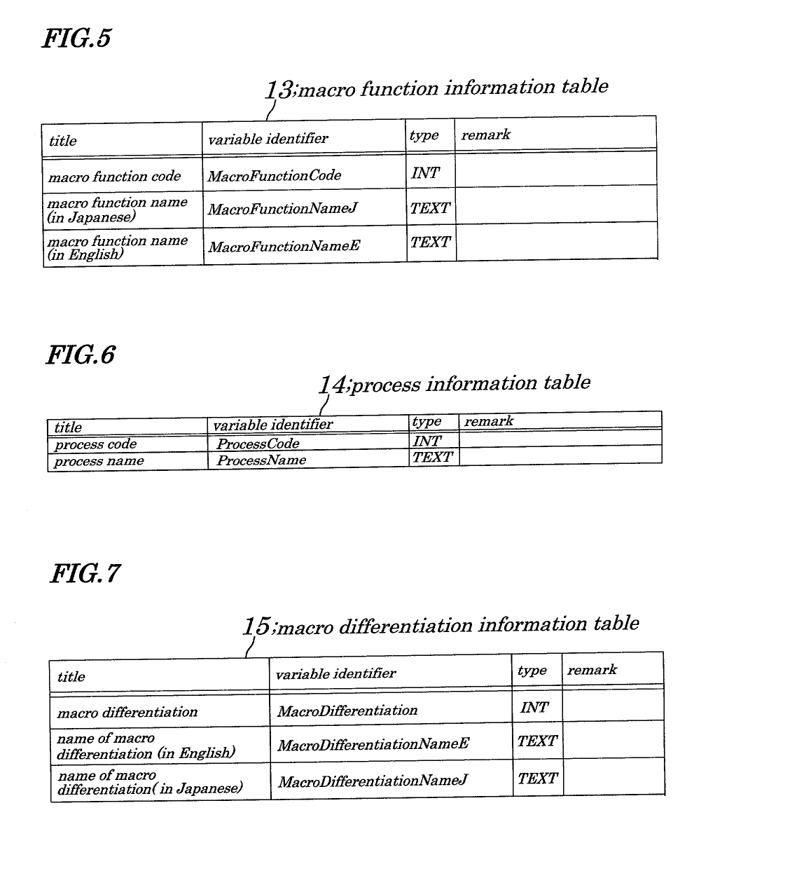

In the process information table 14, as shown in FIG. 6, are stored a process code and a process name assigned to a process used when the macro is produced, which corresponds to the process code. As variable identifiers, [ProcessCode] and [ProcessName] are assigned respectively. The process code is represented by a several-digit integer (not shown). The process name is represented by character strings in a text file format (not shown).

In the macro differentiation information table 15, as shown in FIG. 7, are stored macro differentiation, a name of macro differentiation in English being an English name assigned to each of the macro differentiation which corresponds to the macro differentiation and a name of macro differentiation in Japanese being a Japanese name assigned to the macro differentiation.

As variable identifiers, MacroDifferentiation, MacroDifferentiationNameE, and MacroDifferentiationNameJ are assigned respectively. The macro differentiaton is represented by a several-digit integer (not shown). Each of the names of the macro differentiation in English and Japanese is represented by character strings in a text file format (not shown). That is, the “Cell base soft macro” (in Japanese and English) as the macro differentiation is stored, which corresponds to the macro differentiation “0”. The “Cell base hard macro” (in Japanese and English) as the macro differentiation is stored, which corresponds to the macro differentiation “1” and “manual hard macro” (in Japanese and English) as the macro differentiation is stored, which corresponds to the macro differentiation “2”.

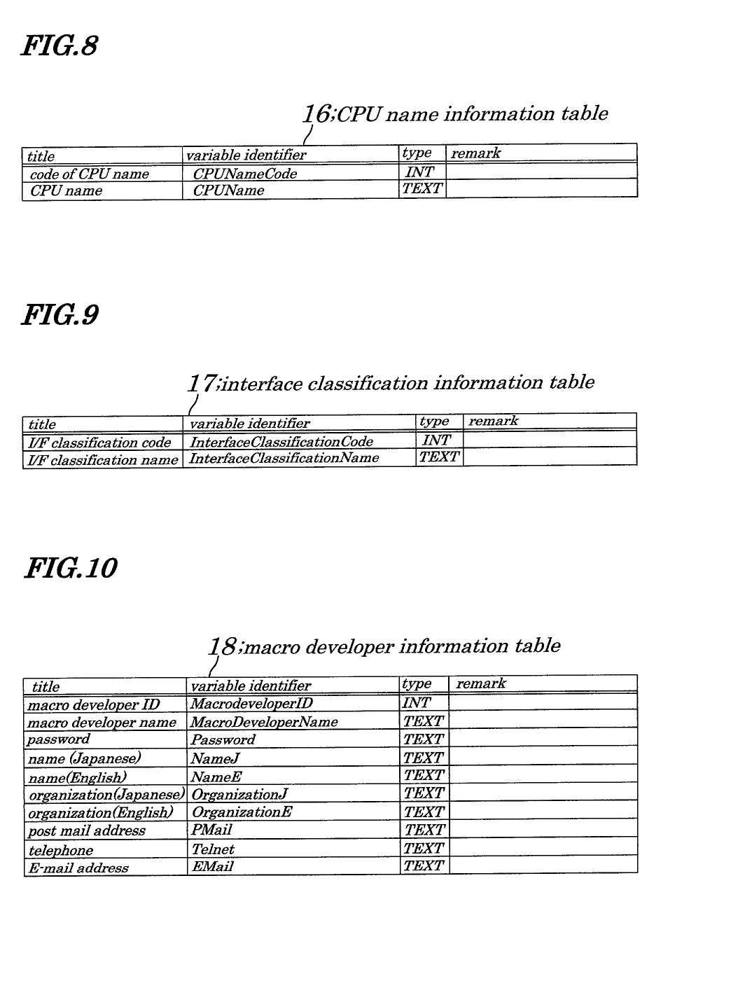

In the CPU name information table 16, as shown in FIG. 8, are stored a code of the CPU name and CPU name being a name assigned to each of CPUs, which corresponds to the CPU name code. As variable identifiers, CPUNameCode and CPUName are assigned respectively. The CPU name code is represented by a several-digit integer (not shown).The CPU name is represented by character strings in a text file format (not shown).

In the interface (I/F) classification information table 17, as shown in FIG. 9, are stored a code of an interface (I/F) classification code and a name of the I/F classification being a name of the interface required when each of the macro transmits or receives data to and from the outside. As variable identifiers, InterfaceClassificationCode and InterfaceClassificationName are assigned respectively. The I/F classification code is represented by a several-digit integer (not shown). The I/F classification name is represented by character strings in a text file format (not shown).

In the macro developer information table 18, as shown in FIG. 10, are stored a macro developer ID being an identification number assigned to a macro developer and required to use the system, a macro developer name being a name of the macro developer, a password that the macro developer uses, a name of the macro developer described in Japanese and in English described in English, an organization to which the macro developer belongs described in Japanese and English, a post mail address of the macro developer, a telephone number of the macro developer, and an E-mail address of the macro developer. As variable identifiers, MacroDeveloperID, MacroDeveloperName, Password, NameJ, NameE, OrganizationJ, OrganizatonE, PMail, Telnet, and EMail are assigned respectively. The macro developer ID is represented by a several-digit integer (not shown). Each of the name of the developer, password, name (Japanese), name (English), organization (Japanese), organization (English), post mail, telephone, and E-mail address is represented by character strings in a text file format (not shown).

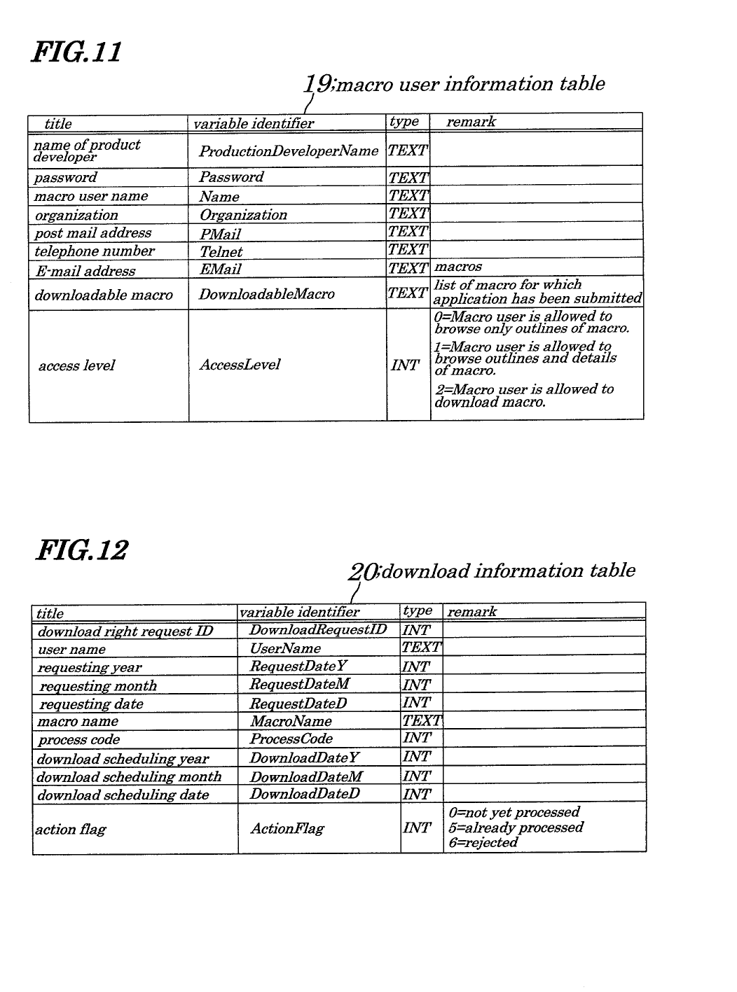

In the macro user information table 19, as shown in FIG. 11, are stored a name of a product developer, a password that the macro user uses, name of a user of the macro, name of organization to which the macro user belongs to, post mail of the macro user, telephone number of the macro user, E-mail address of the macro user, downloadable macro being a list of a macro file that can be downloaded by the macro user from the storage device 2 through the server 1, access level being a level at which the macro user accesses to the storage device 2 through the server 1. As variable identifiers, ProductionDeveloperName, Password, Name, Organization, PMail, Telnet, EMail, DownloadableMacro, and AccessLevel are assigned respectively. Each of the name of the product developer, password, name, organization, post mail, telephone number, E-mail address, and downloadable macro is represented by character strings in a text file format (not shown). The access level is set to “0” when the macro user is allowed to access only an outline of the macro information stored in the storage device 2 and is set to “1” when the macro user is allowed to access only the outline and details of the macro information and is set to “2” when the macro user is allowed to download the macro file. When the access level is set to “0”, the macro user is allowed to browse, for example, the macro call name (Japanese), macro call name (English), macro differentiation, macro function code, outline of functions (Japanese), outline of functions (English), quality classification, size X, size Y, count of the Al wiring layers, cell count, Tr count, action frequency, detection rate of malfunctions, or the like, out of the macro information. When the access level is set to “1”, the macro user can browse all information described in the macro information table 12 shown in FIG. 4. Moreover, even if the access level is set to “2”, the macro user is not allowed immediately to download the macro file, that is, the macro user has to submit an application for a right to download the macro file for each of the macros and, after obtaining the right to download the macro file, is allowed to download it.

The access level in the macro user information table 19 differs from the security level provided in the macro information table 12 in that, the access level is set depending on how much all the macro information is accessed by each macro user, while the security level is set depending on how much each macro information is browsed by all the macro users. Therefore, ordinarily, the security level is set to “0”, however, when the macro developer wants the macro to be handled with specially increased security, the security level is set to “1” and each of the macro users having concluded a special contract with the macro developer is allowed to browse files of the macro.

Next, a relationship between the access level and the quality level is described. Generally, in the case of the macro information for which the quality level is set to “0” to “2”, the access level is set to “2”. In the case of the macro for which the quality level is set to “3”, that is, in the case of the macro provided at the non-assured level, after a special contract is individually concluded between each of the macro developers and the macro user or after a permission from other competitive macro user is obtained, the access level is set to “2”. Moreover, though not shown in the macro user information table 19, information is also described about a right level at which the region level or access level can be set, when necessary, as an exceptional case (by a privilege or in a restricted manner), depending on the region where a macro user exists.

In the download information table 20, as shown in FIG. 12, are stored a download right request ID representing an identification number to be used when a request for the download right being a right to download the macro file desired by the macro user is made to the server 1, a name of the user requesting for the downloading, a year, month, and date when the request for downloading the macro file was made, a name of a macro whose file is requested to be downloaded by the macro user, a process code, a download scheduling year, month, and date when the macro file is to be downloaded, and an “action flag” indicating whether the download processing has been performed or not. As variable identifiers, DownloadRequestID, UserName, RequestDateY, RequestDateM, RequestDateD, MacroName, ProcessCode, DownloadDateY, DownloadDateM, DownloadDateD, and ActionFlag are assigned respectively. Each of the download right request ID, requesting year, requesting month, requesting date, process code, download scheduling year, download scheduling month, and download scheduling date is represented by a several-digit integer (not shown). Each of the user name and macro name is represented by character strings in a text file format (not shown). The action flag is set to “0” when the processing of downloading the macro file has not yet been completed, and is set to “5” when the download processing has been completed and is set to “6” when the request for downloading is rejected.

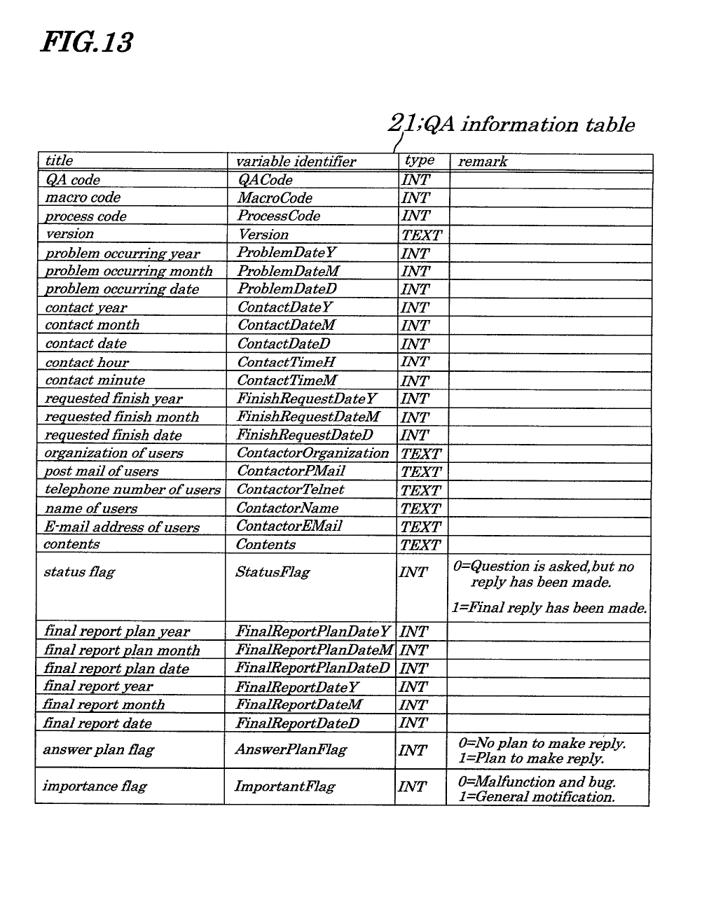

In the QA information table 21, as shown in FIG. 13, are stored a QA code being a number assigned to a question about new development of the macro given by the macro user or malfunctions or information about replies to the question or a like, a macro code of the macro, a process code, a version of the macro, a problem occurring year, problem occurring month, and problem occurring date when information about new development is given by the macro developer or when a question is given from the macro user, a contact year, contact month, contact date, contact hour, and contact minute when the macro developer made a reply to a question, a requested finish year, month, and date when a macro user requested a macro developer to make a reply to a question, an organization to which a questioner belongs, a post mail of a macro user having made a question, a telephone number of a macro user having a question, a name of a questioner, an E-mail address of a questioner, contents made up of information about new development of a macro, concrete contents of a question or reply to a question or contact information or information about malfunctions of a macro found by a macro developer and provided by the macro developer on his/her own initiative, a status flag indicating whether a reply to a question has been made, a final report plan year, month, and date when a macro developer plans to finally make a requested report, a final report year, month, and date when a macro developer made a final report, an answer plan flag indicating a schedule of a macro developer to reply to a question, and an importance flag indicating the degree of importance of a question. As variable identifiers, QACode, MacroCode, ProcessCode, Version, ProblemDateY,ProblemDateM, ProblemDateD, ContactDateY, ContactDateM, ContactDateD, ContactTimeH, ContactTimeM, FinishRequestDateY, FinishRequestDateM, FinishRequestDateD, ContractorOrganization, ContractorPMail, ContractorTelnet, ContactorName, ContactorEMail, Contents, StatusFlag, FinalReportPlanDateY, FinalReportPlanDateM, FinalReportPlanDateD, FinalReportDateY, FinalReportDateM, FinalReportDateD, AnswerPlanFlag, and ImportantFlag are assigned respectively. Each of the QA code, macro code, the process code, the problem occurring year, month and date, the contact year, month, date, hour and minute, the requested finish year, month and date, the final report plan year, month, and date, the final report year, month, and date is represented by a several-digit integer (not shown). Each of the version, organization of users, post mail address of users, name of the users, E-mail address of users, and contents of users is represented by character strings in a text file format (not shown). The status flag is set to “0” when a question is merely given and no reply has been made and is set to “1” when the final reply has been already made. The answer plan flag is set to “0” when a macro developer has no plan to make any answer and is set to “1 ” when the macro developer has a plan to make an answer. The importance flag is set by a macro developer to “0” when a question is related to the occurrence of a malfunction or bug and downloading of a macro file of a macro has to be temporarily halted, if necessary, and is set to “1” when a content of the question is of little importance and a general notification is given as a reply. The macro file storage area 22 (FIG. 2) stores a macro file in which functions of all macros developed by a macro developer and permitted to be registered are described by using programming languages such as the HDL, C language, or a like are stored.

Next, operations of the semiconductor device development-support system will be described in detail.

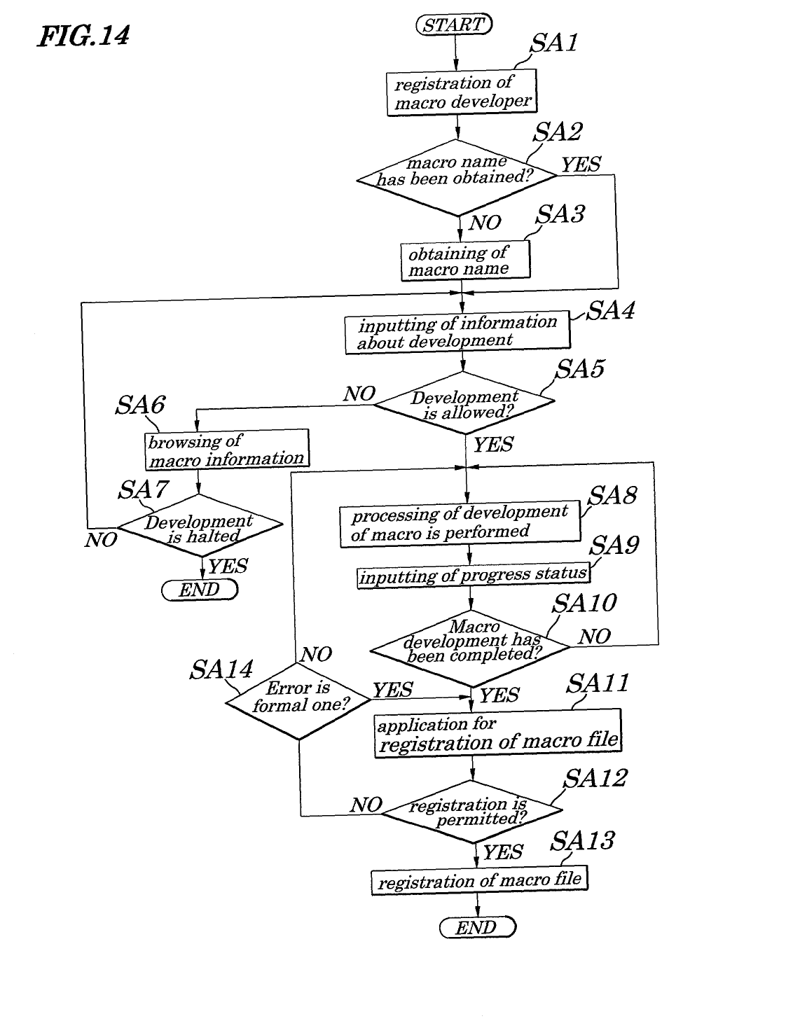

First, processes for developing a macro in which a macro developer develops the macro and registers information about the macro and a macro file with the storage device 2 through the server 1 will be explained by referring to FIG. 14. In the processes for developing a macro, by an operation of inputting units such as a keyboard or a mouse included in the client 41 by a macro developer, a macro development program stored in the internal storage device in the client 4, or external storage devices is read to the CPU included in the client 41 and the macro development program controls operations of the CPU. The CPU included in the client 41, when the macro development processing program starts running, displays various contents of the macro development processing program on a CRT display or a like and, by carrying out data communication with the server 1 in response to operations of a keyboard or mouse by the macro developer, then performs the following processing. In the following descriptions, to simplify explanations, concrete operations or actions of the client 4₁, server 1, or the like are not referred to and the description is presented as if the macro developer directly and independently performs each processing.

First, a macro developer performs processing of macro developer registration by registering himself/herself with the semiconductor device development-support system by inputting, through the keyboard, a name of the macro developer or a name of an organization to which the macro developer belongs (Step SA1). When the registration is permitted by the server 1, the name of the macro developer, the organization, or the like are stored in the macro developer information table 18 shown in FIG. 10. Next, the macro developer judges whether a macro name to be assigned to a macro scheduled to be developed has been obtained or not (Step SA2). If the macro name has not yet been obtained, processing of obtaining a name of a macro is performed (Step SA3).Specifically, the macro developer inputs a macro name that the macro developer wants to use and checks whether a same macro name as is input by the macro developer has been already used by retrieving information stored in the macro name information table 11. If the macro name is not yet used and when the use of the macro name is permitted by the server 1, the macro developer obtains the macro name input by the macro developer as a macro name that can be used. If the macro name has been already used, a different name is input and is checked by retrieving information in the macro name information table 11. The processing is repeated until the use of the macro name is permitted. The server 1, when obtaining a macro name, assigns a macro code to the macro name. When the macro developer has already obtained the macro name or when the macro developer has obtained a new macro name, the macro developer inputs information about development of a macro to be newly developed (Step SA4). The information about development includes a name of a developer, a name of a macro, a name of a process, a development schedule, an outline of functions or a like. The server 1, based on information about development of the macro and on outlines of functions in particular, judges whether any macro having same outlines of functions of the macro scheduled to be developed has been already developed, is under development, or is scheduled to be developed or not, by retrieving related information from the macro information table 12 shown in FIG. 4 and, if the macro to be scheduled has not yet been developed, is not under development, or is not scheduled to be developed, notifies the macro developer, by an E-mail, that the scheduled macro is allowed to be developed. The server 1 also stores a name of a developer, a name of the macro, a name of a process, scheduled year, month, and date of its release, an outline of functions (Japanese and English) in a storage region having a corresponding macro code in the macro information table 12 in FIG. 4 and sets its quality class to “4” showing a yet-to-be-completed level. Moreover, the server 1, after assigning a QA code being a serial number to be used for controlling question information in an order of receipt of information about the development and question, stores the development information, that is, a macro code, process code, version, problem occurring year, month, and date and contents being concrete contents of the development information in a storage region having a corresponding QA code in the QA information table 21 shown in FIG. 13.

On the other hand, the server 1, if a macro having the same functions as those of the macro input by the macro developer has been already developed, is under development, or is scheduled to be developed, notifies the macro developer of a code of the macro having similar functions by an E-mail.

Therefore, the macro developer, when receiving the notification that the macro having the same function as those of the macro to be developed by the macro developer has been already developed, is under development, or is scheduled to be developed (Step SA5), browses the macro information table 12 shown in FIG. 4, based on the macro code (SA6), and determines whether the development of the macro has to be halted because outlines of the functions of the macro to be developed by the macro developer are the same as those already developed, being under development, or being scheduled to be developed and because a change of a plan of the macro to be developed is impossible or the development of the macro is continued because a wide change is not required though a partial change is necessary (Step SA7). When the development of the macro is halted, the server 1 terminates a series of processing and when the development is continued, processing of inputting information about the development required for corrections of the outline of the functions is performed (Step SA4). The macro developer, when receiving the notification that the macro having the same function as those of the macro that the macro developer is planning to develop has been already under development, or has been already scheduled to be developed by other macro developer, may discuss, with the other macro developer who is now developing or is scheduled to develop the macro, by an E-mail or, if necessary, by a direct meeting, a possibility that the macro can be developed in cooperation with each other or that either of the macro developers develops singly and; when it is concluded that one of the macro developers singly develops the macro, how and what kind of a request from the other developer the one who is planning to develop the macro should accept. In this case, an exchange of the E-mails between the macro developers can be carried out in accordance with the processing of solving questions described later.

On the other hand, the macro developer, when receiving the notification from the server 1 that the macro can be or is allowed to be developed, performs processing of the development of the macro (Step SA8). Since the processing of the development of the macro is the same as has been performed conventionally, its description is omitted. It takes several days to several months to complete the development of the macro, though depending on its size. Therefore, the macro developer inputs a state of progress of the macro when every workday is over (Step SA9). In this case, when the development period is made longer than expected originally or made shorter, the scheduled date is changed by inputting processing. That is, the server 1 changes the “planned release year, month, and date” and the “data updating year, month, and date” stored in the macro information table 12. Thus, when information about the development of the macro and about states of the progress of the development are input, since the information is stored in a predetermined storage area in the macro information table 12, the present macro developer and other macro developers can browse them. In some cases, the present macro developer or other macro developers who have browsed the information of the macro being scheduled to be developed or being under development, in order to obtain more detailed information, transmit information including a question about a scheduled development date of the above macro or its expected functions. In this case, the developer of the macro who has already started to develop the macro, when receiving the notification that the question has been transmitted from macro users and/or other developers, browses the information about requests or expectations from the other macro users and/or other macro developers stored in the storage area having the QA code, in the QA information table 21, attached to the information about the development of the macro being presently developed by the above macro developer, changes the scheduled development date depending on amounts of the questions or requests and, if necessary, changes functions of the macro being developed. Moreover, detailed processing to be performed by the entire semiconductor device development system required when the macro developer makes a reply to questions from the macro users and/and other macro developers will be described later. The macro developer repeats the processing of the macro development and of inputting the progress status described above until the development is completed (Step SA8 to SA10).

Next, the macro developer, when the development is completed (Step SA10), makes an application for the registration of a macro file with the macro file storage area 22 (Step SA11). At the time of making the application for the registration, the macro developer performs a checking on operations of the macro, and judges whether the macro is provided at the general assurance level at which the macro is assured of operations without any problem under general conditions, or the macro is provided at the non-operational condition level at which the macro does not operate under specified conditions, or the macro is provided at the operational condition level at which the macro is assured of operations under specified conditions, or the macro is provided at the non-assured level at which the macro is assured of operations only under very-limited conditions and further adds information about these levels, the operation frequency, detection rate of malfunctions or the like. Moreover, the macro developer adds information about the security level for the macro information and the macro file, that is, about whether all the macro users can browse the macro information or macro file or only the macro users who have concluded a special contract with the macro developer can browse them and further adds information about a price level, that is, the information about a price at which the macro is sold. The server 1, after having checked contents of the macro file for which an application for the registration is made, notifies the macro developer whether the contents of the macro file are suitable for the registration. The macro developer, if the notification from the server 1 shows that a permission to register is given, notifies the acknowledgement to the server 1 (Step SA12 and SA13). The server 1 registers the macro file with the macro file storage area 22 and stores a date of the registration and necessary information in the macro information table 12 and other information tables. If the notification from the server 1 indicates that the registration of the macro file is not permitted and its reason is that there is a formal error such as a mistake in the registration application document drawn up by the macro developer, the macro developer corrects the application (Step SA14 and SA11) and, if the notification from the server 1 indicates that the registration is not permitted and its reason is that there is an essential or substantial error such as a mistake in contents of the macro file, the macro developer has another try to perform the processing of the development of the macro (Step SA14 and SA8).

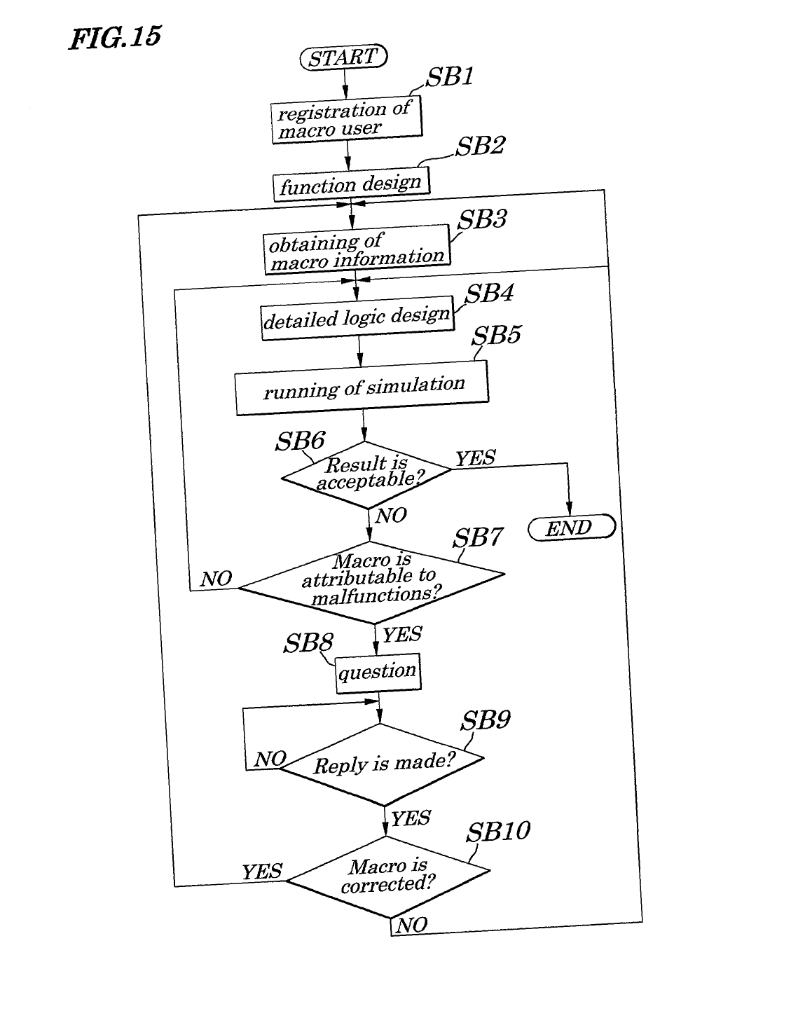

Next, processing of the development of a semiconductor device using the semiconductor device development assistance system by a macro user will be described by referring to a flowchart in FIG. 15. In the processing of the development of the semiconductor device, the macro user reads the semiconductor device development processing program stored in the internal storage device or the external storage device, to the CPU making up the client 5₁ by manipulating a keyboard, mouse, or a like included in the client 5₁ and operations of the CPU are controlled by the read semiconductor device development processing program. The CPU included in the client 5₁, when the semiconductor device development processing program is started, after displaying various contents of the program on the CRT display screen, performs the following processing, in response to the operations of the keyboard, mouse, or a like and by carrying out data communication with the server 1 through the communication unit or the Internet 3. In the following descriptions, to simplify explanations, concrete operations or actions of the client 5₁, server 1, or the like are not referred to and the description is presented as if the macro developer directly and independently performs each processing.

First, a macro user performs processing of macro user registration by registering himself/herself with the semiconductor device development-support system by inputting, through the keyboard, a name of the macro user or a name of an organization to which the macro user belongs (Step SB1). When the registration of the macro user is permitted by the server 1, the name of the macro user or the organization to which the macro user belongs is registered in the macro user information table 19 shown in FIG. 11. At the time of the registration, in accordance with a contract concluded between the macro user and a manager of a system managing the semiconductor development-support system, an access level of the macro file is set to any one of levels including the “0” level at which the macro user is allowed to access only an outline of the macro information stored in the storage device 2, the “1” level at which the macro user is allowed to access only the outline and details of the macro information, or the “2” level at which the macro user is allowed to download the macro file. The access level is basically set, based on the assurance level, security level, or price level of each macro. Moreover, the above access level can be changed depending on the region level which is set based on a region where each macro user exists and/or the right level is set as an exceptional case (by a privileged manner or in a limited manner).

Next, the macro user, after having performed function design (Step SB2) for determining relationships among functional blocks including the CPU or a plurality of peripheral devices and operations of the internal parts of each of functional blocks, based on specifications of a semiconductor device whose development has been decided by system design, performs processing of obtaining information including macro information about macros including basic logic elements such as NAND gates, NOR gates, or the like and basic logic circuits constructed by combinations of a plurality of such basic logic elements with latches, counters, or a like and of obtaining the macro file, from the storage device 2 connected to the server 1 through the Internet 3 (Step SB3). The processing of obtaining information about the macro will be explained later.

Then, the macro user, based on the macro information obtained by the processing of obtaining the macro information and macro file, performs detailed logic design of each of the functional blocks whose internal operations has been defined by the function design and, after forming a simulation model of the semiconductor device (Step SB4), compiles the simulation model together with the macro file and, by having the client 5₁ run the simulation, carries out verification of the semiconductor devices (Step SB5).

Next, if the result of the simulation shows no problem (Step SB6), the macro user terminates the development of the semiconductor device. If the result of the simulation shows any problem, the macro user checks whether the problem is attributable to the macro itself (Step SB7) or to the detailed logic design and when the detailed logic design is judged to be its cause, the macro user has another try of the detailed logic design and repeats the design until a desired result from the simulation is obtained (Step SB4 to SB6).

On the other hand, when it is judged that the problem is attributable to the macro itself, the macro user creates questions about malfunctions of the macro and transmits the question information to the server 1 by an E-mail (Step SB8). The processing to be performed by the entire semiconductor device development system to solve the problem and to reply to the question will be described in detail later. Moreover, when the macro user receives a reply or contact information about malfunctions of the macro from the macro developer informing that the macro developer has corrected the macro information of the macro and the macro file, the macro user obtains the corrected macro information and macro file to have another try of the detailed logic design and repeats the detailed logic design and the related simulation until a satisfactory simulation result is acquired (Step SB9 to SB10 and SB3 to SB6). On the other hand, when the macro user receives a reply or contact information showing that the macro would not be corrected and that the malfunction has occurred because the macro had been used at a point near to functional limitations of the macro or the macro had been used in a wrong way, the macro user has another try of the detailed logic design and repeats the detailed logic design and the simulation until a satisfactory simulation result is obtained (Steps SB4 to SB6) or the macro user has another try of the detailed logic design by obtaining information of another macro and another macro file and repeats the detailed logic design and the simulation until the satisfactory simulation result is obtained (Steps S3 to S6).

Thus, by setting the access level in accordance with the expenses or a predetermined budget for the use of the macro, the use of the macro depending on the price level is made possible and there is no case in which costs for using the macro exceed a budget. Moreover, by transmitting keywords of the information required for the development of the semiconductor device, if necessary, in addition of the question about malfunctions of the macro or the like, to the server 1, the macro user can obtain information about related macro acquired by retrieving the information based on the keyword information and the related macro file collectively.

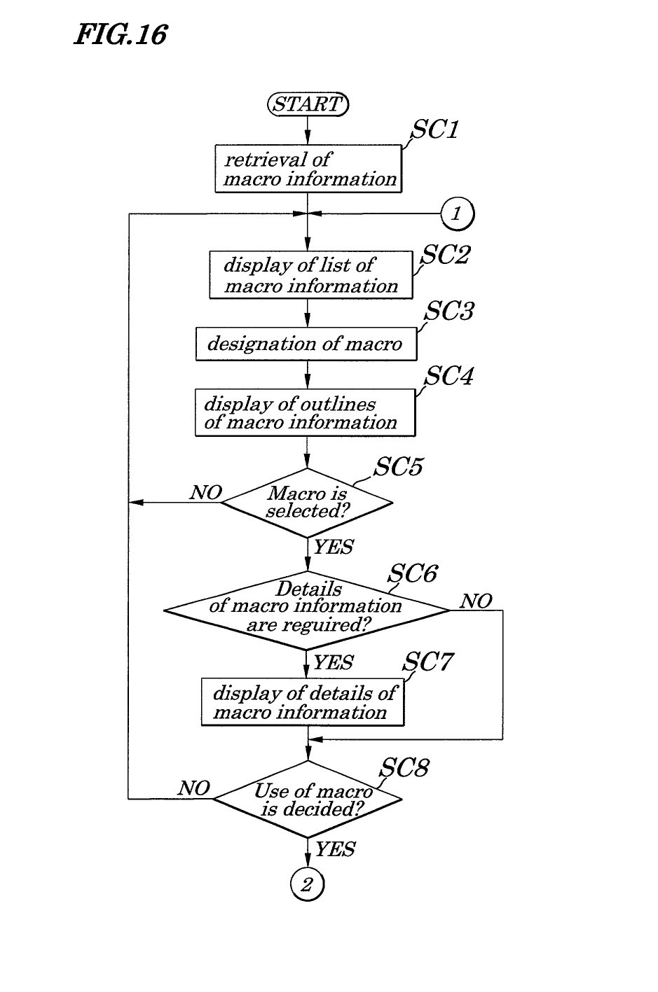

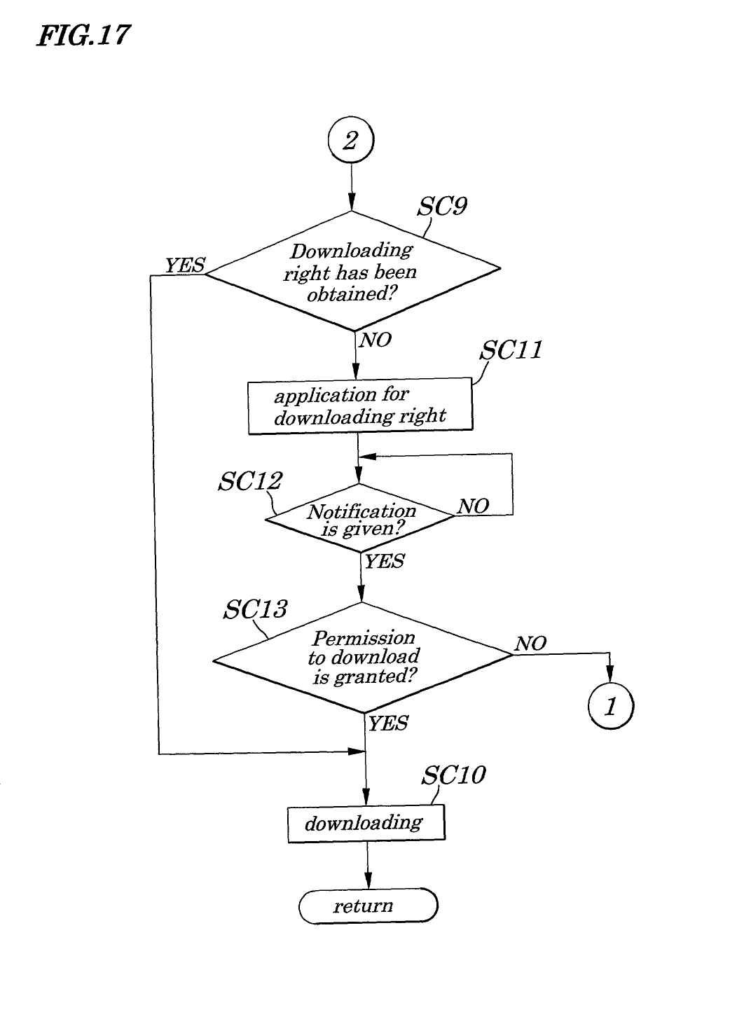

Next, processing of obtaining the macro information will be described in detail by referring to FIGS. 16 and 17. In the examples, let it be assumed that the access level of the macro user is set to “2” at the time of the registration of the macro user.

First, the macro user retrieves desired macro information by using keywords such as a macro code, macro function, macro differentiation code, process name, or a like (Step SC1). Since the retrieval causes a list of macro information to appear on the CRT display (Step SC2), the macro user selects one of macros, out of a plurality of macros being displayed on the CRT display, which is suitable to specifications of the semiconductor device to be developed and instructs outlines of the selected macro to be displayed on the CRT display (Step SC3). This causes outlines of the macro information to be displayed on the CRT display or the like (Step SC4). Specifically, outlines of functions (in Japanese and English) or the likes stored in the macro information table 12 are displayed. Therefore, the macro user judges whether the macro is selected or not, by referring to outlines of the functions (in Japanese or English) (Step SC5) displayed on the CRT display and, if the macro user does not select the displayed macro, by again displaying the list of the macro information on the CRT display, repeats the above processing until a desired macro to be used is selected (Step SC2 to SC4).

On the other hand, if the macro user selects the macro whose outlines of functions (in Japanese or English) are displayed on the CRT unit or the like, the macro user decides whether details of the macro information are displayed on the CRT unit or not and, if they are decided to be displayed on the CRT unit, issues an instruction to display them (Step SC6). This causes details of the macro information to be displayed on the CRT unit (Step SC7). Specifically, all information described in the macro information table 12 shown in FIG. 4 is displayed. The macro user decides if the macro is used by referring to details of the macro information being displayed, or immediately not by referring to details of the macro information (Step SC8) and, if the macro is not used, the macro user displays again the list of the macro information on the CRT display and repeats the processing of selecting the desired macro until the use of the macro is decided (Step SC2 to SC7). The macro user, when deciding whether the macro user uses the macro or not, judges whether the assurance levels or operational conditions of the macro can meet specifications of the semiconductor device to be developed by the macro user. Though a macro being at a yet-to-be-completed level, even if its information is selected and is desired to be displayed by the macro user, is not displayed and cannot be downloaded, since only information about its scheduling date and/or its outline of functions can be obtained, the information can be used as useful reference information and, if necessary, the development of the semiconductor device can be delayed properly until the macro is developed. However, the macro user can submit questions about the macro with the yet-to-be-completed level to the macro developer and makes a request for detailed information about the macro including the scheduling date and functions. Processing of the entire semiconductor device to handle such questions will be described later.

On the other hand, the macro user, when having decided the use of the selected macro, judges whether the macro user has obtained a right to download the macro file of the macro or not (Step SC9 in FIG. 17) and, if the macro user has already obtained the downloading right, after having downloaded the macro file (Step SC10), starts the detailed logic design (Step SB4 in FIG. 15). If the macro user has not yet obtained the downloading right, the macro user makes an application for the downloading right (Step SC11) to the server 1. Then, when a notification is given from the server 1 (Step SC12) notifying that a permission to download the macro file is granted (Step SC13), the macro user, after having executed the downloading of the macro file (Step SC10), starts the detailed logic design (Step SB4 in FIG. 15). The server 1 refers to a list of the macro stored in the macro user information table 19 shown in FIG. 11 as a downloadable macro and, if the macro is described in the list, reads a macro file of the macro from the macro file storage area 22 and transmits the read macro file to the client 5₁.

Moreover, the application for the right to download the macro file may be made for an individual macro and, if other macros are incorporated into one macro or macros are compatible to each other or two or more macros have similar characteristics, the application may be made for a plurality of macros collectively.

If the notification is given from the server 1 (Step SC12) showing that the permission to download the macro file is not granted (Step SC13), since it proves that the selected macro cannot be used, the macro user, in order to find out another macro, displays again the list of the macro information on the CRT display (Step SC2 in FIG. 16) and repeats the processing of selecting another macro until a macro file of a usable macro can be downloaded and then starts the detailed logic design (Step SB4 in FIG. 15). The examination to be made by the server 1 to grant the downloading right is performed with considerations given not only to a viewpoint as to whether the access level for the macro is set to “2” indicating that the macro is downloadable, as described in the macro user information table 19 shown in FIG. 11, but also to a viewpoint including the quality class, security level, if necessary, region level, and right level of the macro, an actual state of contracts (content of the contract, concluded date of the contract, payment results of expenses, contract concluded with other macro user, or like) concluded between the macro user and the macro developer.

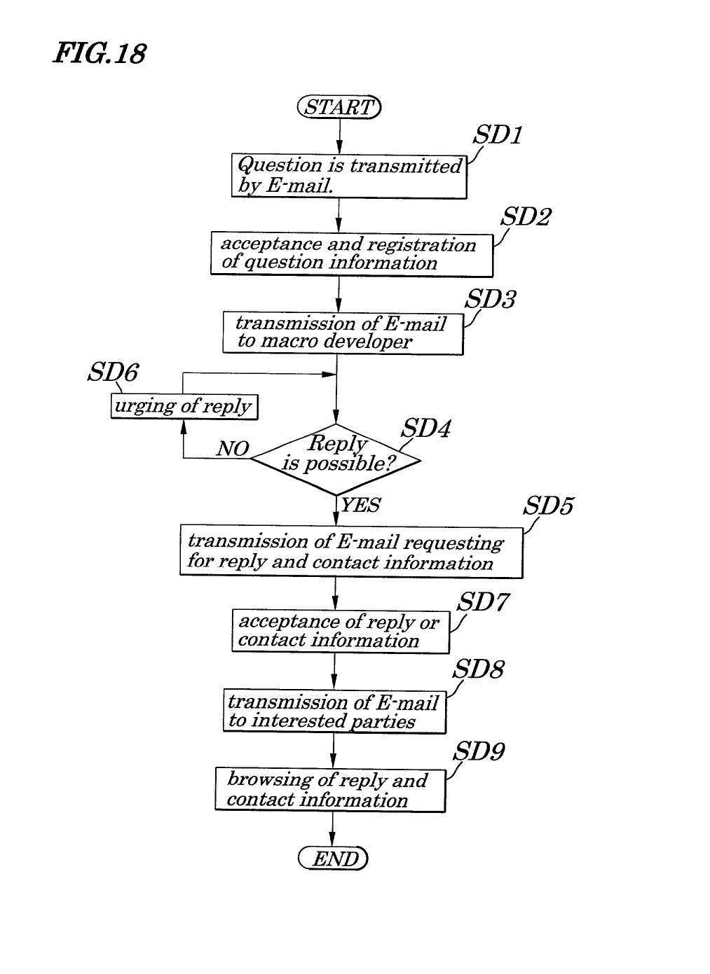

Next, processing of solving questions will be described by referring to a flowchart shown in FIG. 18. Since not only the macro user but also the macro developer and the server are involved in the processing of solving questions, the processing is described as processing to be performed by the entire semiconductor device development-support system. First, the macro user transmits question information about the macro in which a malfunction is found, including a macro code, process code, together with information about an organization to which a questioner belongs, contact of the questioner, and name of the questioner, by an E-mail to the macro developer (Step SD1). Two concrete examples of the questions or problems with the macro will be described here. The first example of the question is that, when a clock tree is formed by connecting six buffers, as a first stage buffer, to an output of a first buffer whose output is supplied to an input of an external clock and by connecting, in parallel, three buffers as a second stage buffer to any one of outputs of the first stage buffer, as a result, an output from the second buffer becomes unstable. The second example of the question is that, when a timer making up one chip microcomputer used for a parent macro is used for a child macro constructed by using the parent macro as a model and its timer consecutive reading function, which had not been used for the parent macro, to enable a value of a timer to be read consecutively two times, is used, an unstable value is read at the time of the second reading.

The server 1, when judging that the received question information is one that has undergone processing of the macro user registration (Step SB1 in FIG. 15) and has been transmitted from a questioner having downloaded macro files of the macro, accepts the question information and, after assigning a QA code being a serial number used to manage the question information to the received question information in order of receiving the question information, stores the question information, information about the questioner including an organization to which the questioner belongs, post mail address, telephone number, name, and E-mail address of the questioner, and further a problem occurring year, month, and date or the like in the storage region having the corresponding QA code in the QA information table shown in FIG. 13 and then sets the status flag to “0” (Step SD2. In this case, the server 1, if it has already accepted the same question information about the macro, stores the question information in the storage region in which the already-registered information has been stored and informs the macro user that the server 1 has already accepted the same question information. This allows the macro user to expect that a reply to the question would be made earlier than originally scheduled, thus serving to minimize a delay in the development of the semiconductor device.

Next, the server 1 retrieves a macro code from question information having the QA code stored in the QA information table 21 and, by referring to the macro developer information table 18 shown in FIG. 10, based on the macro code, retrieves a developer name of the macro and an E-mail address of the developer and then transmits an E-mail to the macro developer informing that the question information corresponding to the QA code assigned to the macro has arrived (Step SD3). The server 1 adds a requested finish year, month, and date showing a limit time when a reply or contact to the question information should be made, to the question information by an E-mail.

The macro developer having received the E-mail from the server 1, judges whether a reply to the question is possible or not (Step SD4) and, if an immediate reply is possible, transmits the reply to the server 1, by E-mail via the Internet 3 (Step SD5) The macro developer, when transmitting the reply or contact information to the questioner, notifies the questioner whether no correction is scheduled or whether a temporary halt of downloading the macro file of the macro is necessary because of malfunctions or bugs of the macro or whether a general notification only is given because of no importance of contents of the question.

In the case of the question shown as the first example above, the macro developer, judges that the macro is being used at a point near to functional limitations of the macro and, therefore, no correction is made by the macro developer and a reply is made by designating the case as a general failure having no importance. If the macro developer takes a temporary measure to avoid the failure, the macro developer makes a proposal that, when six or more buffers are connected, in parallel, as the first stage buffer, the number of buffers to be connected in parallel, as the second stage buffer, to any one of outputs of the first stage buffer should be limited to two pieces or the number of buffers to be connected, in parallel, as the first stage buffer, should be limited to up to five pieces, and describes, as a plan to give attentions, the above limitation of the number of the buffers in the item of attention and restriction (in Japanese and English) of the macro information table 12 shown in FIG. 4.

Moreover, in the case of the question as shown in the second example, there is a mistake in the design in which a locking signal to inhibit updating of a read buffer of a timer remains active when no rise of a clock between a time of first reading and a second reading. As a result, if a rise of the clock at a time of the second reading occurs, the locking signal becomes non-active, causing the read buffer to be updated in the middle of reading and indefinite value to be read. In this case, the macro developer makes a reply that a measure to correct the failure would be taken, notifying the macro user that the problem including a malfunction or a bug is of importance. The macro developer makes a proposal, as a temporary measure, that the macro user is requested to avoid the use of a timer consecutive reading function that allows a value of the timer to be read consecutively twice and also makes a promise that the version is updated (for example, from V1.00 to V1.01) because the correction of the failure in a circuit is required and informs the macro user of the final report plan year, month, and date.

On the other hand, if the server 1 does not receive a reply from the macro developer about a requested finish date of a requested finish month of a requested finish year, an E-mail urging a reply or contact information is transmitted to the macro developer (Step SD6) from the server 1. In this case, temporary measures to correct malfunctions may be given as the reply or contact information from the macro developer and there is no need to provide a final measure required to solve malfunctions to the macro user. Either of a report informing that a measure is under review or a mere acknowledgement of the question information is acceptable.

The server 1, when receiving a reply or contact information by the requested finish date or in response to the request and after having confirmed that the reply has been transmitted from the macro developer who has completed the registration as the macro developer (Step SA1 shown in FIG. 14) and actually has developed the macro, accepts the reply or contact information. Then, the server 1 stores the reply or contact information provided from the macro developer, a contact year, month, and date, subsequent to the questions given by the macro user, in the storage region having the QA code in the QA information table 21 shown in FIG. 13 and sets the status flag to “1” and the answer plan flag to either of“0” (that is, no measure is scheduled to be taken) or “1” (that is, some measures are scheduled to be taken) and the importance flag to either of“0” (that is, contents of the question are malfunctions or bugs of the macro and downloading of a macro file of the macro is halted temporarily if necessary) or “1” (that is, contents of the question are of little importance and the reply can be a general notification) (Step SD7).

In the case of the first example, the answer plan flag is set to “0” and the importance flag to “1” and, in the case of the second example, the answer plan flag is set to “1” and the importance flag to “0” and the version is updated to a “V1.01” and a year, month, and date is stored as the final report plan year, month, and date given by the macro developer.

Next, the server 1, when there is any macro user who has already downloaded the macro file of the macro and who has made the question, any macro user who has been granted a right to download the macro file of the macro but has not yet downloaded the macro file of the macro and there is a developer of a parent macro that the present macro has been derived from, transmits an E-mail notifying that the reply and contact information about the question having the QA code have been provided by the macro developer to interested parties such as the macro developer who has developed the parent macro (Step SD8). In this case, the E-mail to the questioner making up the interested parties is transmitted to an E-mail address of the questioner stored in the QA information table 21 shown in FIG. 13. To transmit the E-mail to other macro users being other interested parties, by using the download information table 20 shown in FIG. 12, after extracting a requester whose action flag is set to “0” showing that the downloading has not yet been performed or set to “1” showing that the downloading has been completed from a list of requesters for the downloading right of the same macro as is the object of the question, the E-mail is transmitted to an E-mail address of an macro user, stored in the macro user information table 19 shown in FIG. 11, having the same name as that of the extracted requester. To transmit the E-mail to the developer of the parent macro being one of the interested parties, after extracting a name of the parent macro from a list of parent macro names stored in the macro information table 12 shown in FIG. 4 and further extracting a name of the developer of the same macro name as the parent macro name extracted from a list of developer names stored in the macro name information table 11 shown in FIG. 3, the E-mail is transmitted to an address of the same developer name as the extracted developer name out of developers stored in the macro developer information table 18 shown in FIG. 10.

The macro user being the questioner or a macro user, out of the interested parties, who has already downloaded the macro file of the macro and is not aware of malfunctions, by browsing the reply and contact information corresponding to the QA code in the QA information table 21 shown in FIG. 13 (Step SD9) and, as described by referring to the flowchart shown in FIG. 15, obtains amended macro information or macro information about another macro and has another try of detailed logic design and simulation.

A macro user, out of the interested parties, who has acquired a downloading right but not yet downloaded the macro file, by browsing the reply or contact information corresponding to the QA code in the QA information table 21 shown in FIG. 13 (Step SD9), performs some procedures including downloading of the macro file after having known malfunctions of the macro or correction of them, halting of the downloading of the macro file to change the present macro to another one or a like.

A developer of the parent macro, out of the interested parties, by browsing the reply or contact information corresponding to the QA code in the QA information table 21 shown in FIG. 13, performs a supply of information by transmitting a method for a measure to correct a malfunction of the macro if there is a proper method that the developer has or a method for another measure if the malfunction of the child macro is attributable to the parent macro, to the macro developer of a child macro. The developer of a parent macro, when the malfunction of the child macro is attributable to the malfunction of the parent macro of the child macro, if there is a parent macro (a parent macro of the parent macro) used as a model for development of the parent macro, transmits an E-mail message informing the malfunction to the developer of the parent macro of the parent macro and, if the parent macro has a child macro other than the child macro in which the present malfunction is found, if necessary, transmits the E-mail message informing the malfunction to a developer of the child macro. Moreover, when a question about development of a macro being under development is given by a macro user or other macro developers, since the processing of handling the question is the same as described above except the case where interested parties are limited to the questioner, the description will be omitted.

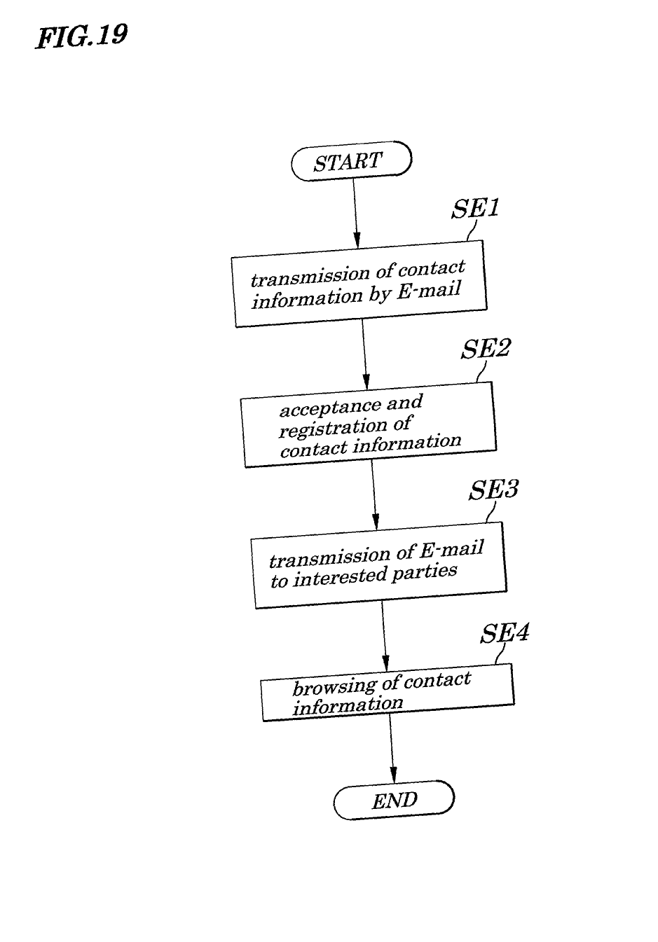

Next, processing of providing information in which a macro developer finds out malfunctions of a macro and provides, on a voluntary basis, information about measures against the malfunctions and cautions in use will be described by referring a flowchart shown in FIG. 19.

First, a macro developer, when finding out malfunctions of the macro that the macro developer has developed, transmits information about the measure to correct malfunctions or contact information including cautions to be taken in using the macro to the server 1 by an E-mail (Step SE1). In this case, since contents of the contact information to be provided by the macro developer are the same as in the case of processing of the reply or contact information and its description will be omitted.

The server 1, when confirming that the macro developer who has provided the contact information has been already registered in the macro developer registration processing (Step SA1 in FIG. 14) and that the contact information has been surely transmitted from the registered macro developer, accepts the contact information and, after having assigned a QA code being a serial number used to control the contact information and question information to the contact information in order of the receipt of the contact information and question information, then stores the contact information in a question item having the QA code in the QA information table 21 shown in FIG. 13 in a storage region and a contact year, month, and date, and sets the status flag to “1” and the answer plan flag depending on the contact information (Step SE2).

Next, the server 1 transmits an E-mail informing that contact information having the QA code has been provided from the macro developer to interested parties including a macro user who has already downloaded macro files of the macro but has not been aware of its malfunction, a macro user who has acquired a right to download the macro file of the macro but has not yet downloaded the macro file and a macro developer who has developed a parent macro if the macro in question has its parent macro (Step SE3). In this case, the method of transmitting the E-mail is almost the same as in the case of the processing of transmitting the E-mail to the interested parties (Step SD8) described above and its description will be omitted. The interested parties browses the contact information corresponding to the QA code in the QA information table 21 shown in FIG. 13 (Step SE4) and performs necessary processing depending on a position or a status of each of the interested parties. Since the method of browsing the information by the interested parties is the same as in the case of browsing the reply and contact information (Step SD9 in FIG. 18) and its description will be omitted.

As described above, according to the embodiment of the present invention, the semiconductor development-support system is made up of the server 1 in which macro information and a macro file of a macro are stored, clients 4₁ to 4ₘ operated by a macro developer, clients 5₁ to 5ₙ operated by a macro user, and the Internet 3 used to connect the server 1, clients 4₁to 4ₘ and clients 5₁ to 5ₙ and is operated in a manner that question information about malfunctions of the macro that is used by the macro user for development of the semiconductor device is stored in the QA information table 21 and question information about the macro is transmitted from the macro user to the macro developer who has developed the macro through the Internet 3 and a request for a reply from the macro developer is urged on a predetermined date or a like and that a reply from the macro developer or information about correction made by the macro developer is transmitted, through the Internet 3, only to interested parties including a macro user who has downloaded the macro file of the macro including the questioner, a macro user who has acquired a right to download the macro file of the macro but not yet downloaded the macro file and, if the macro has its parent macro, a parent macro developer that has developed the parent macro. Since the question information is transmitted in a manner that the information is put in order, the macro developer that makes a reply to the question can transmit the reply smoothly and rapidly without being interfered with in his work.

Moreover, when a macro file is amended, since the macro file stored in the storage device 2 being used in common is amended, all that the macro developer has to do is one time processing and, since the server 1 automatically notifies interested parties of the amendment of the macro file, it takes neither time nor labor. Furthermore, since the amendment of the macro file is notified to all interested parties, a proper measure can be taken at an appropriate time, thus enabling prompt development of the semiconductor device and preventing damage caused by incomplete development of the semiconductor device due to malfunctions of the macro.

Moreover, when the macro in question has its parent macro, since the reply and contact information only is notified to the macro developer of the parent macro, a prompt measure can be taken if the present malfunction is attributable to that of the parent macro and, if necessary, by notifying a macro developer of the parent macro or, if the parent macro has another child macro other than the child macro in which the present malfunction is found, a macro developer of the other child macro, of the occurrence of the present malfunctions, a prompt measure to correct the malfunction can be taken and the occurrence of the malfunction of the other child macros can be prevented.

Since the contact information about malfunctions that the macro developer himself has found is notified properly to interested parties, the macro user can prevent the occurrence of malfunctions and can develop the semiconductor device without using the macro having a risk of the occurrence of the malfunction or using the macro after becoming aware of the malfunction, thus, in any case, enabling efficient development of the semiconductor device.

Also, in the example, since macro developer is allowed to set the quality level and security level, if necessary, region level or right level for each macro and to set the access level to each of the macro users, enabling the macro developer to focus his/her energy on development without the need for an individual discussion to conclude a contract to handle a macro requiring high security and thus preventing the macro developer being interfered with his/her original work. Moreover, since the macro user uses a macro after knowing an actual quality level that the macro has, there is no case where development of the semiconductor device is interfered with by using the macro assuming that the macro would have higher quality level or where a useless trouble between the macro developer and the macro user occurs and where effort becomes useless and time is wasted because a verification level is increased more than needed due to no information of the level of quality to the macro used.

Moreover, a macro developer, before starting development of a new macro, can receive information that a macro having a function being similar to that of the macro that the macro developer is going to develop has been already developed, is under development, or is scheduled to be developed, double or overlapped development of the macro can be avoided, which can prevent time and labor being wasted and, further by developing the new macro in cooperation with another developer, the macro developer may develop a macro having more excellent function, which enables efficient development of the macro.

Also, since a macro developer or a macro user can browse information about a new macro being under development and since a desire and/or expectation of the macro user for the macro development is stored in the QA information table 21, the macro developer of the macro can respond flexibly to demands by the macro user and, since the desire and/or expectation are reflected in the development of the macro, more efficient development is made possible.

It is apparent that the present invention is not limited to the above embodiments but may be changed and modified without departing from the scope and spirit of the invention. For example, in the above embodiment, the present invention is applied to a case where a macro is developed at a stage of logic design of the semiconductor device or a semiconductor device is developed using the macro, however, it can be applied to a case where a functional block is developed at a stage of system design of the semiconductor device or the semiconductor device is developed using the functional block. That is, at the stage of system design, operations and configurations of an entire system using a CPU, ROM, RAM, buffer, and a plurality of peripheral devices as one functional block are so decided as to obtain desired functions, where a person who develops only functional blocks by handling the functional block such as the CPU, ROM, RAM, buffer, and the plurality of peripheral devices as if each of them were a macro, can be regarded as such a macro developer as described above and a person who develops a semiconductor device by using the functional blocks focusing attention to their functions only, can be regarded as such a macro user as described above. Thus, though there are a difference in size between the macro and the functional block, a same problem may occur, which can be solved in the same manner as described above. In this case, examples of the peripheral devices include a timer counter, A/D (Analog/Digital) converter, speech recognition circuit, speech synthesis circuit, and image processing circuit. Recently, same functions as those of the peripheral devices can be implemented by software (it is called middleware). That is, a system designer can freely develop a semiconductor device without giving considerations to whether a function of the functional block is implemented by hardware or middleware and, at a final stage when a configuration of a semiconductor device is decided, may judge whether the function of the functional block should be implemented by hardware or by middleware, by taking into consideration a performance of the CPU to be used, timing of operations, area to be occupied by hardware, and capacity of the ROM to be stored by software. Though the operations of the middleware depends on the performance of the CPU to be used, the middleware whose operations can respond to each CPU can be prepared in advance.

Moreover, the present invention can be applied to development of software by considering as if a routine of the software or one unified set of processing were equivalent to the macro. That is, since, in a case of large-sized piece of software, each routine of the software is individually and separately by a plurality of software developers and finally these routines are integrated into one software and there are some cases where new software is developed by combining some routines that have been already developed with routines having new functions, it is possible to regard each of the routines as the above macro. Recently, a distributed object system has been developed in which an object integrally including data and software to process the data is installed in a plurality of servers in a distributed manner and a client reads these objects through the Internet to use them as if these objects are installed within the devices of the client. When each of the objects in the distributed system is considered to be the macro, if a malfunction occurs in the object itself, this invention can be applied to the distributed object system. Though, in the case of the distributed system, one kind of the object has to be installed in one server, unlike development of semiconductor devices, since the distributed object system requires prompt and immediate measures, by applying the present invention, more excellent effects can be obtained.

Also, in the above embodiment, the server urges a macro developer to make a reply to questions asked by a macro user by showing the requested finish year, month, and date, however, the system of the present invention can be so configured that the macro developer is forced to pay a penalty by the number of dates of delays in making the reply or contact information, from the requested finish year, month, and date or that the payment of the penalty is to be made by so-called electronic settlement (that is, electronic automatic drawing from bank accounts or electronic payment by credit cards on the Internet). By doing this, since the macro developer is under psychological pressure, it is made possible to obtain the reply or contact information. In this case, the system can be also so configured not only that the server serves as a third party as in the case of the embodiment, but that the penalty is automatically paid by the number of dates in delays in making the reply or contact information, from the requested finish year, month, and date, by electronic settlement.

Moreover, in the above embodiment, each of tables including the macro name information table 11 to the QA information table 21 is made up of an individual table linked using a macro code, macro function code, and process code, however, each of them may be made up of a main table storing all information and individual information table having link information, if necessary, to be linked to the main table storing all information.

Furthermore, in the above embodiment, the server 1, clients 4₁ to 4ₘ and clients 5₁ to 5ₙ are connected through the Internet 3, however, the system can be so configured that the server 1, clients 4₁ to 4ₘ and clients 5₁ to 5ₙ may be connected through an intranet, that is, a network within a company, both the Internet and intranet may be used to connect them.

What is claimed is:

1. A system development method for developing a system using a development-support system made up of a server used to provide information about functional units each implementing a different function and files describing said different functions, at least one developer client to develop said functional units and at least one user client to develop said system configured to perform desired operations by combining said functional units, wherein all of said server, developer client, and user client are connected through an internet, comprising:
a first step, to be taken by said user client, of registering an operator of said user client as a user of said development-support system;
a second step, to be taken by said user client, of obtaining, by referring to information about said functional units, files describing a plurality of said functional units which are needed for development of said system;
a third step, to be taken by said user client, of developing said system by combining files describing said plurality of said functional units;
a fourth step, to be taken by said user client, of transmitting question information about said functional units or keyword information regarding information required for development of said system to said server, when said system does not operate properly due to malfunctions of said functional units or when said information required for development of said system is to be acquired; and
a fifth step, to be taken by said user client, of obtaining, when necessary, a file of another functional units, based on reply information to said question information or on said information retrieved according to said keyword information and, if necessary, of changing design to have another try of developing said system and checking operations of a developed system.

2. The system development method according to claim 1, wherein, in said second step, said files of said plurality of said functional units are allowed to be obtained only when an application for individual or collective acquisition of said files is made and a right to acquire said files is granted through examination of the application for acquisition of each of said functional units or of every collective group of said functional units.

3. The system development method according to claim 1, wherein, in said fourth step, when any question about said functional units that has been already asked is contained in said question information, a notification informing that said question about said functional units has been already asked is provided, and other information required for development of said system is able to be obtained.

4. The system development method according to claim 1, wherein said reply information to said question information is transmitted to each of both said user clients and said developer clients which is operated by a user having already acquired said files including a user having transmitted said question information, a user having wanted to obtain said files but having not yet obtained said files and, when there is a model functional unit that has been used as a model for development of said functional unit, a user having developed said model functional unit.

5. The system development method according to claim 1, further comprising a sixth step of transmitting, when said developer of said functional units has found a malfunction of said functional units, contact information notifying that said functional units have said malfunction and information about a method for taking a measure against said malfunction.

6. The system development method according to claim 1, wherein said system is a semiconductor device and said functional unit is a basic logic element or a basic logic circuit constructed by combining a plurality of said basic logic elements.

7. The system development method according to claim 1, wherein said system is a semiconductor device and said functional units include a central processing unit, storage device, buffer, and peripheral device and wherein a file of said peripheral device is so constructed as to be able to select either of a file to implement its function by using hardware or a file to implement its function by using software.

8. The system development method according to claim 1, wherein said system is software and said functional units are routines or objects to perform predetermined processing.

9. A storage medium storing system development program for causing a computer to execute a method for developing a system using a development-support system made up of a server used to provide information about functional units each implementing a different function and files describing said different functions, at least one developer client to develop said functional units and at least one user client to develop said system configured to perform desired operations by combining said functional units, wherein all of said server, developer client, and user client are connected through an internet, comprising:
a first step, to be taken by said user client, of registering an operator of said user client as a user of said development-support system;
a second step, to be taken by said user client, of obtaining, by referring to information about said functional units, files describing a plurality of said functional units which are needed for development of said system;
a third step, to be taken by said user client, of developing said system by combining files describing said plurality of said functional units;
a fourth step, to be taken by said user client, of transmitting question information about said functional units or keyword information regarding information required for development of said system to said server, when said system does not operate properly due to malfunctions of said functional units or when said information required for development of said system is to be acquired; and
a fifth step, to be taken by said user client, of obtaining, when necessary, a file of another functional units, based on reply information to said question information or on said information retrieved according to said keyword information and, if necessary, of changing design to have another try of developing said system and checking operations of a developed system.

10. A development-support system comprising:
a server used to provide information about functional units each implementing a different function and files describing said different function,
at least one developer client to develop said functional units:
at least one user client to develop a system configured to perform desired operations by combining said functional units; and
wherein all of said server, said developer client, and said user client are connected through an internet,
wherein said user client obtains files of a plurality of said functional units, develops said system by combining files of said plurality of functional units and checks operations of the developed system and, as a result, when said developed system does not operate properly due to a malfunction of any one of said functional units, transmits question information about said malfunction of said functional unit to said server,
wherein said server, after having accepted and registered said question information, transmits said question information to said developer client operated by said developer client of said functional units,
wherein said developer client transmits reply information to said question information to said server,
wherein said server, after having accepted and registered said reply information, transmits said reply information to said user client or another developer client operated by a user having interests in said functional units.

11. The development-support system according to claim 10, wherein said user client makes an application for acquisition of each of a plurality of functional units or of said plurality of functional units collectively, said server examines said application for each of said plurality of functional units or for said plurality of functional units collectively and grants said user client a right to acquire, and said user client, based on the granted right, obtains files of said functional unit from said server.

12. The development-support system according to claim 10, wherein said server, only when said question information has been registered as coming from a user of said development-support system and said question information has been transmitted from a user having obtained files of said functional units, accepts said question information.

13. The development-support system according to claim 10, wherein said server, when having already accepted and registered said question information about said functional units, registers said question information together with question information that has been already registered and transmits contents of said registration to said developer client.

14. The development-support system according to claim 10, wherein said server transmits a date when a reply to said question information should be made to said developer client and, if there is no reply by said date, transmits information urging said developer client to make a reply and, if there is still no reply even after said date, again transmits information urging said developer client to make a reply on every predetermined date, to said developer client.

15. The development-support system according to claim 14, wherein said server transmits information notifying that a predetermined penalty is imposed every time said reply is delayed by said one date behind said date or by said predetermined dates behind said date, together with said information urging said developer client to make said reply, and an amount equivalent to said penalty is automatically drawn from a bank account every time said reply is delayed by one date behind said date or by predetermined dates behind said date.

16. The development-support system according to claim 10, wherein said server accepts said reply information only when said reply information has been transmitted by a user who has been registered as a user of said development-support system and who has developed said functional unit.

17. The development-support system according to claim 10, wherein said interested user is a user having obtained said files including a user having transmitted said question information, a user having wanted to obtain said files but having not yet obtained said files or, when there is a model functional unit that has been used as a model for development of said functional unit, a user having developed said model functional unit.

18. The development-support system according to claim 10, wherein said developer client transmits, when said developer of said functional unit has found a malfunction of said functional unit, contact information notifying that said functional unit has said malfunction and information about a method for taking a measure against said malfunction, to said server.

19. The development-support system according to claim 10, wherein said system is a semiconductor device and said functional unit is a basic logic element or a basic logic circuit constructed by combining a plurality of said basic logic elements.

20. The development-support system according to claim 10, wherein said system is a semiconductor device and said functional unit is a central processing unit, storage device, buffer, and peripheral device and wherein a file of said peripheral device is so constructed as to be able to select either of a file to implement its function by using hardware or a file to implement its function by using software.

21. The development-support system according to claim 10, wherein said system is software and said functional units are routines or objects to perform predetermined processing.

22. A storage medium storing system development control program for causing a computer to execute functions of a development-support system comprising:
a server used to provide information about functional units each implementing a different function and files describing said different function,
at least one developer client to develop said functional units:
at least one user client to develop a system configured to perform desired operations by combining said functional units; and
wherein all of said server, said developer client, and said user client are connected through an internet,
wherein said user client obtains files of a plurality of said functional units, develops said system by combining files of said plurality of functional units and checks operations of the developed system and, as a result, when said developed system does not operate properly due to a malfunction of any one of said functional units, transmits question information about said malfunction of said functional unit to said server,
wherein said server, after having accepted and registered said question information, transmits said question information to said developer client operated by said developer client of said functional units,
wherein said developer client transmits reply information to said question information to said server,
wherein said server, after having accepted and registered said reply information, transmits said reply information to said user client or another developer client operated by a user having interests in said functional units.
